(19) United States
(12) Patent Application Publication
(10) Pub. No.: US 2026/0208362 A1
(43) Pub. Date: Jul. 23, 2026

(54) INFORMATION PROCESSING APPARATUS, INFORMATION PROCESSING METHOD, AND STORAGE MEDIUM

(71) Applicant: NEC Corporation, Tokyo (JP)

(72) Inventors: Masumi ICHIEN, Tokyo (JP); Yuki TAYA, Tokyo (JP); Hiroyuki OYAMA, Tokyo (JP)

(73) Assignee: NEC Corporation, Tokyo (JP)

(21) Appl. No.: 19/157,731

(22) PCT Filed: Feb. 27, 2023
(86) PCT No.: PCT/JP2023/007038

§ 371 Date: Aug. 19, 2025

(51) Int. Cl. B25J 9/16; G06T 7/50

(52) U.S. Cl. CPC B25J 9/1697; B25J 9/1653; G06T 7/50

(57) ABSTRACT

An information processing apparatus 100 of the present disclosure includes a first estimating unit 121 that acquires first measurement information obtained by measuring the shape of an object, and estimates an estimated shape of the object based on the first measurement information, and a second estimating unit 122 that acquires second measurement information obtained by measuring the shape of the object after the object is manipulated by a robot, and estimates an object shape based on the estimated shape and the second measurement information.

### TECHNICAL FIELD

The present disclosure relates to an information processing apparatus, an information processing method, and a storage medium.

### BACKGROUND ART

In recent years, robots have been introduced in various fields, and tasks have been automated. For example, Patent Literature 1 describes a system for picking up items using a robot. In particular, Patent Literature 1 describes picking up an item from a group of items that is made up of a plurality of stacked items. In such a situation, in Patent Literature 1, the height of each item is calculated by calculating the height of the top surface of the item located on the topmost layer and the number of layers of the items.

### CITATION LIST

### Patent Literature

[Patent Literature 1] JP 2019-5871 A

### SUMMARY OF INVENTION

### Technical Problem

However, in the technology described in Patent Literature 1 mentioned above, the height of each item is calculated from the height of the top surface of the item and the number of layers, so that the stacked items must be of the same type, that is, the same height. This causes a problem that when items of different types or sizes are stacked, the exact size of each item cannot be recognized, and the robot cannot perform accurate manipulation.

For this reason, an object of the present disclosure is to provide an information processing apparatus capable of solving the above-mentioned problem, that is, a problem that it is impossible to perform accurate operation on stacked objects by a robot.

### Solution To Problem

An information processing apparatus, according to one aspect of the present disclosure, is configured to include
a first estimating unit that acquires first measurement information obtained by measuring a shape of an object, and estimates an estimated shape of the object based on the first measurement information, and
a second estimating unit that acquires second measurement information obtained by measuring the shape of the object after the object is manipulated by a robot, and estimates an object shape based on the estimated shape and the second measurement information.

An information processing method, according to one aspect of the present disclosure, is configured to include
acquiring first measurement information obtained by measuring a shape of an object, and estimating an estimated shape of the object based on the first measurement information, and
acquiring second measurement information obtained by measuring the shape of the object after the object is manipulated by a robot, and estimating an object shape based on the estimated shape and the second measurement information.

A program, according to one aspect of the present disclosure, is configured to cause a computer to execute processing to
acquire first measurement information obtained by measuring a shape of an object, and estimate an estimated shape of the object based on the first measurement information, and
acquire second measurement information obtained by measuring the shape of the object after the object is manipulated by a robot, and estimate an object shape based on the estimated shape and the second measurement information.

### ADVANTAGEOUS EFFECTS OF INVENTION

With the configurations as described above, the present disclosure enables accurate manipulation by a robot on stacked objects.

### BRIEF DESCRIPTION OF DRAWINGS

FIG. 1 is a block diagram illustrating a configuration of an information processing apparatus according to a first example embodiment of the present disclosure.

FIG. 2 is a diagram illustrating a state of processing by the information processing apparatus disclosed in FIG. 1.

FIG. 3 is a diagram illustrating a state of processing by the information processing apparatus disclosed in FIG. 1.

FIG. 4 is a diagram illustrating a state of processing by the information processing apparatus disclosed in FIG. 1.

FIG. 5 is a flowchart illustrating an operation of the information processing apparatus disclosed in FIG. 1.

FIG. 6 is a block diagram illustrating a hardware configuration of an information processing apparatus according to a second example embodiment of the present disclosure.

FIG. 7 is a block diagram illustrating a configuration of the information processing apparatus according to the second example embodiment of the present disclosure.

### DESCRIPTION OF EMBODIMENTS

### First Example Embodiment

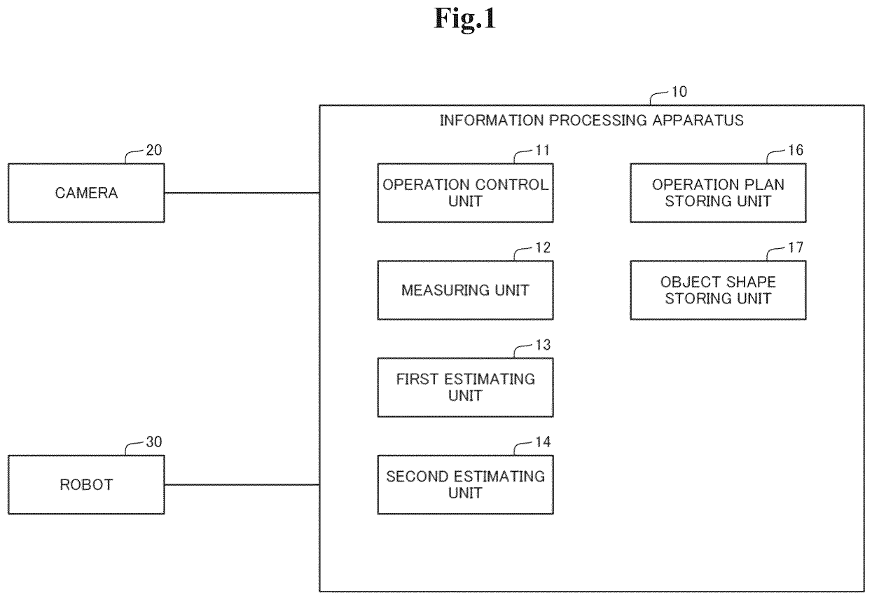

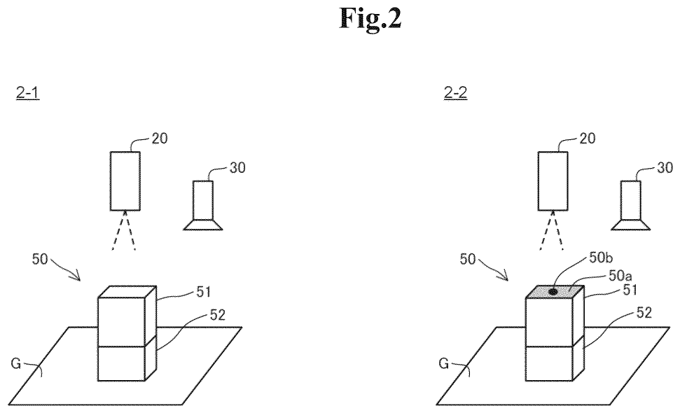

A first example embodiment of the present disclosure will be described with reference to FIGS. 1 to 5. FIG. 1 is a diagram for explaining a configuration of an information processing apparatus, and FIGS. 2 to 5 are diagrams for explaining processing operation by the information processing apparatus.

### [Configuration]

The information processing apparatus 10 of this example embodiment has a function of estimating the shape of an object in order to manipulate the object by a robot. In this example embodiment, stacked objects are objects to be manipulated by a robot, and the robot performs manipulation to pick up an object and move it to a target location. As illustrated in FIG. 1, a camera 20 and a robot 30 are connected to the information processing apparatus 10.

As described below, the camera 20 captures an image in which the shape and the distance of an object can be measured, in response to a command from the information processing apparatus 10. For example, the camera 20 is installed above the space in which an object 50 is placed, and captures a distance image from above the object 50. However, the camera 20 may capture any image as long as it is an image in which the shape and the distance of an object can be measured. Instead of the camera 20, a measuring device capable of measuring the shape and the distance of an object may be provided.

In this example embodiment, the robot 30 is configured with a robot arm. The robot arm is equipped with a manipulation part at the tip of the arm that adsorbs and holds an object. As will be described later, in response to commands from the information processing apparatus 10, the robot 30 operates to move while holding an object, and move and place the object at a desired location. It should be noted that the robot 30 is not limited to holding an object by adsorption, and may hold an object in any structure, such as by gripping it.

The information processing apparatus 10 is configured of one or more information processing apparatuses each including an arithmetic logic unit and a memory unit. As illustrated in FIG. 1, the information processing apparatus 10 includes an operation control unit 11, a measuring unit 12, a first estimating unit 13, and a second estimating unit 14. The functions of the operation control unit 11, the measuring unit 12, the first estimating unit 13, and the second estimating unit 14 can be realized by the arithmetic logic unit executing a program for realizing each function stored in the memory unit. The information processing apparatus 10 also includes an operation plan storing unit 16 and an object shape storing unit 17. The operation plan storing unit 16 and the object shape storing unit 17 are each configured of a storage device. The respective components will be described in detail below.

The operation plan storing unit 16 stores therein operation plan information of the robot 30. For example, the operation plan information is planned based on an initial position and a target position of the object 50 set in advance, and includes information for controlling the robot 30 to realize the operation plan such as picking up the object 50 from the initial position, moving it to the target position, and placing it there. As will be described later, the operation plan information can be created and changed each time the object shape of the object 50 is estimated.

The object shape storing unit 17 stores shape information of the object 50 to be manipulated. For example, the shape information is stored each time an image of the object 50 is measured and the object shape of each object is estimated. In this example embodiment, the object 50 is defined such that two objects 51 and 52, that is, a first object 51 and a second object 52, are stacked in the height direction (z direction) on a base G as illustrated in FIG. 2 (2-1), and are placed at a preset initial position on the base G. However, the object 50 is not limited to two stacked objects, and more objects may be stacked, or may be arranged side by side in contact with each other in the horizontal direction.

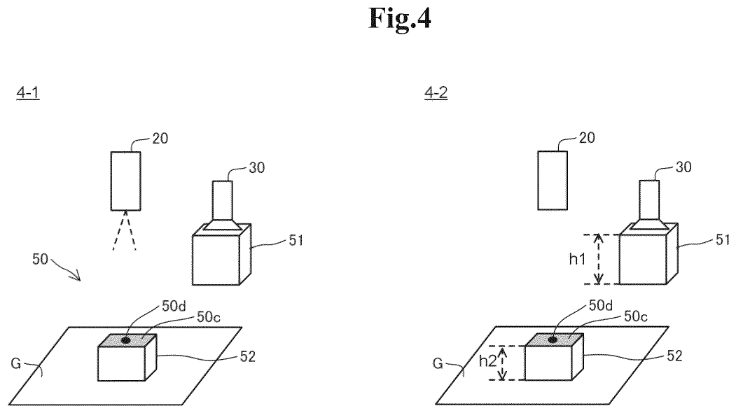

The operation control unit 11 controls the operation of the robot 30 based on the operation plan information, and performs manipulation on the object 50. Along with it, the operation control unit 11 instructs the measuring unit 12 to measure the object 50. For example, the operation control unit 11 instructs the measuring unit 12 to capture images of the object 50 and obtain measurement information before and after the robot 30 performs a picking operation on the object 50. As an example, the operation control unit 11 instructs to perform imaging and measurement for the first time before performing a picking operation on the object 50 as illustrated in FIG. 2, and then instructs to perform imaging and measurement for the second time after performing a picking operation on the object 50 as illustrated in FIG. 4. The operation control unit 11 may then instruct to further perform imaging and measurement after further performing a picking operation on the object 50.

In response to a command from the operation control unit 11, the measuring unit 12 captures an image of the object 50 with the camera 20 and measures the shape of the object 50 from the image. For example, when the measuring unit 12 receives an instruction to image and measure the object 50 for the first time before picking up the object 50, the measuring unit 12 captures the first image using the camera 20 from above the object 50 at the initial position where the object 50 is previously set to be placed. Then, the measuring unit 12 measures first measurement information including the shape of the top surface of the object 50 and the height position of the top surface from the image captured the first time. As an example, for the object 50 consisting of two stacked objects 51 and 52 as illustrated in FIG. 2 (2-1), the measuring unit 12 captures an image from above using the camera 20 as illustrated in FIG. 2 (2-2), and measures a shape 50a of the top surface of the object 50 and a height position 50b of the top surface from the image as the first measurement information. At this time, as the shape 50a of the top surface of the object 50, the measuring unit 12 measures the length of each side located on the outer periphery of the shape 50a as well as the angles between the respective sides, and measures the shape of the top surface such as a square or rectangle and the size. Furthermore, as the height position 50b of the top surface of the object 50, the measuring unit 12 measures the height 50b from the base G to the top surface. Then, the measuring unit 12 transfers the first measurement information to the first estimating unit 13.

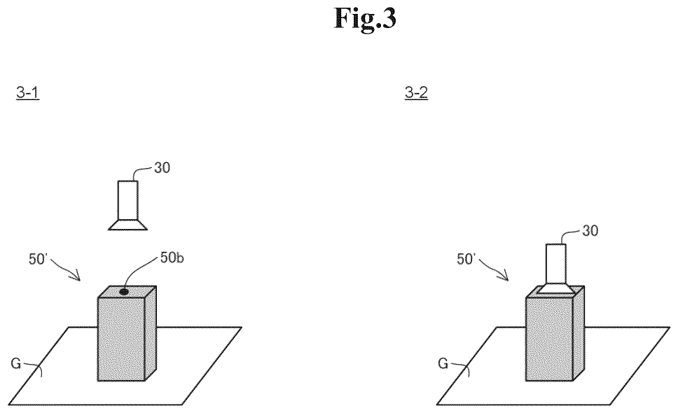

When the first estimating unit 13 receives the first measurement information including the shape 50a and the height 50b of the stacked object 50 from the measuring unit 12, the first estimating unit 13 estimates an estimated shape of the object 50 from the first measurement information. That is, as illustrated in FIG. 3 (3-1), the first estimating unit 13 estimates the estimated shape of the object 50 on the assumption that the object 50 measured using the first measurement information is a single rectangular parallelepiped object 50′. As an example, the first estimating unit 13 estimates the estimated shape of one rectangular parallelepiped object 50′ by using the shape 50a included in the first measurement information as the bottom shape of the object 50′ and the height 50b included in the first measurement information as the height of the object 50′.

Then, the operation control unit 11 creates an operation plan based on the estimated shape of the object 50′, and controls the operation of the robot 30 so as to perform a picking operation according to the operation plan. In this case, the operation control unit 11 controls the position of the robot 30 so that the robot 30 holds the object 50′ at the height position 50b of the top surface of the estimated shape of the object 50′, as illustrated in FIG. 3 (3-1) and (3-2). Then, the operation control unit 11 adsorbs and holds the object 50′ by the robot 30, and as a result, as illustrated in FIG. 4 (4-1), only the first object 51 located at the top of the stacked objects 50′ is held and moved by the robot 30. As described above, the operation control unit 11 instructs to capture the second image and perform measurement for the second time after performing the picking operation on the object 50.

In addition, when the measuring unit 12 receives an instruction from the operation control unit 11 to image and measure the object 50 for the second time after the object 50 is picked up, the measuring unit 12 captures the second image with the camera 20 from above the object 50 at the location before the object 50 was picked up, that is, the initial position where the object 50 is set to be placed. Then, the measuring unit 12 measures second measurement information including the shape of the top surface of the object 50 and the height position of the top surface from the image captured for the second time. As an example, as illustrated in FIG. 4 (4-1), after the first object 51 is picked up from the object 50 consisting of the two stacked objects 51 and 52, the measuring unit 12 captures an image of the remaining object 50, that is, the second object 52, from above using the camera 20, and measures a shape 50c of the top surface of the second object 52 and a height position 50d of the top surface from the image as the second measurement information. At this time, as the shape 50c of the top surface of the second object 52, the measuring unit 12 measures the length of each side located on the outer periphery of the shape 50c and the angles between the respective sides, and measures the shape of the top surface itself such as a square or rectangle and the size. Furthermore, the measuring unit 12 measures the height 50d from the base G to the top surface as the height position 50d of the top surface of the second object 52. Then, the measuring unit 12 transfers the second measurement information to the second estimating unit 14.

When the second estimating unit 14 receives the second measurement information of the shape 50c and the height 50d of the object 50 after the picking operation, that is, the second object 52, from the measuring unit 12, the second estimating unit 14 estimates the object shape of the second object 52 from the second measurement information. That is, the second estimating unit 14 estimates the estimated shape of the object 50 measured using the second measurement information, and in this example embodiment in particular, estimates the shape of the remaining object 50 on the assumption that it is a single second object 52. As an example, the second estimating unit 14 estimates the object shape of the rectangular parallelepiped second object 52, as illustrated in FIG. 4 (4-2), where the shape 50c included in the second measurement information is the bottom shape of the second object 52 and the height 50d included in the second measurement information is a height h2 of the second object 52.

Furthermore, the second estimating unit 14 estimates the object shape of the first object 51 from the second measurement information and the estimated shape of the first object 51. For example, as illustrated in FIG. 4 (4-2), the second estimating unit 14 can calculate the actual height h1 of the first object 51 being picked up by subtracting the height 50d (h2) of the second object 52 from the height 50b of the estimated shape of the object 50′ assumed to be a single object measured from the first measurement information as described above, and estimates it as the object shape of the first object 51 and corrects it.

In the above, the second estimating unit 14 estimates the object shape of the second object 52 from the second measurement information, but the object shape of the second object 52 may be estimated in the same manner as the first object 51 described above. That is, the second estimating unit 14 may first estimate the estimated shape of the second object 52 from the second measurement information, and then further estimate the object shape of the second object 52 based on an image taken after picking up the second object 52 in a manner similar to the method of estimating the object shape of the first object 51 described above.

Then, the above-mentioned operation control unit 11 creates an operation plan based on the estimated object shapes of the first object 51 and the second object 52, and controls the operation of the robot 30 to perform a picking operation according to the operation plan. In this case, as illustrated in FIG. 4 (4-2), the operation control unit 11 first creates an operation plan to move the first object 51 being picked up to the target position and place it there, according to the height h1 of the first object 51, and controls the operation of the robot 30. That is, the operation control unit 11 takes into account the height h1 of the first object 51 and creates an operation plan to properly place the first object 51 on the base G without dropping it or crushing it, and controls the operation of the robot 30.

In addition, the operation control unit 11 controls the position of the robot 30 so that the second object 52 is held at the height position 50c (h2) of the top surface of the object shape of the second object 52. Then, the operation control unit 11 causes the robot 30 to adsorb and hold the second object 52, and the second object 52 is held by the robot 30 and moved.

Here, the operation control unit 11 temporarily stops the operation control of the robot 30 when instructing to perform imaging and measurement for the second time after performing a picking operation on the first object 51. That is, the operation control unit 11 temporarily stops the operation control of the robot 30 when picking up the first object 51 and imaging and measuring the second object 52 left behind as described above and estimating the object shapes of the first object 51 and the second object 52. Then, after estimating the object shapes of the first object 51 and the second object 52, the operation control unit 11 calculates a new operation plan for the robot 30, and then resumes the operation control of the robot 30 based on the new operation plan.

### [Operation]

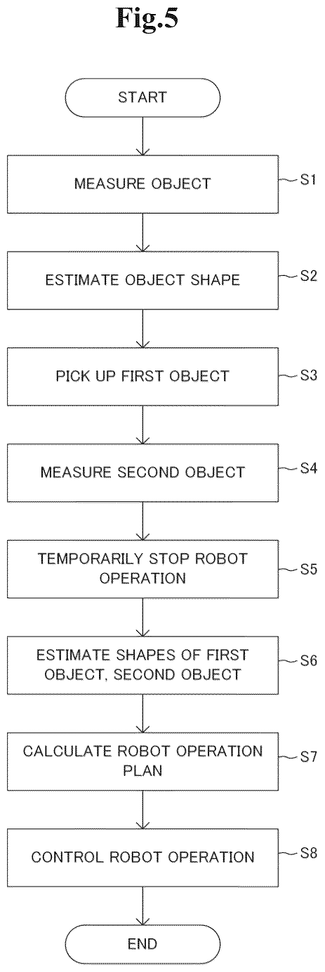

Next, operation of the information processing apparatus 10 will be described with reference to the flowchart of FIG. 5.

The information processing apparatus 10 controls operation of the robot 30 based on the operation plan information, and starts manipulation on the object 50. At this time, the information processing apparatus 10 performs image capturing and measurement for the first time before performing a picking operation on the object 50 (step S1). Specifically, as illustrated in FIG. 2 (2-2), the information processing apparatus 10 captures an image from above the object 50 in which two objects 51 and 52 are stacked, and measures the shape 50a of the top surface of the object 50 and the height position 50b of the top surface from the image, as first measurement information. Then, as illustrated in FIG. 3, the information processing apparatus 10 determines that the object 50 is a single object 50′ based on the first measurement information, and estimates the estimated shape of the single rectangular parallelepiped object 50′ by taking the shape 50a included in the first measurement information as the bottom surface of the object 50′ and the height 50b included in the first measurement information as the height of the object 50′ (step S2).

Then, the information processing apparatus 10 creates an operation plan based on the estimated shape of the object 50′, and controls the operation of the robot 30 so as to perform a picking operation according to the operation plan. In this case, the information processing apparatus 10 controls the position of the robot 30 so as to hold the object 50′ at the height position 50b of the top surface of the estimated shape of the object 50′, as illustrated in FIG. 3 (3-1) and (3-2). As a result, in the information processing apparatus 10, as illustrated in FIG. 4 (4-1), only the first object 51 located at the top of the stacked objects is held and moved by the robot 30 (step S3).

Then, after picking up the first object 51, the information processing apparatus 10 captures an image for the second time from above the object 50 at the location before it was picked up, that is, the location where the remaining object 50 is placed, as illustrated in FIG. 4 (4-1). Then, as illustrated in FIG. 4 (4-1), the information processing apparatus 10 measures second measurement information including the shape 50c of the top surface of the remaining object 50 and the position of the height 50d of the top surface from the second image (step S4). That is, in this case, the information processing apparatus 10 measures the shape 50c of the top surface of the remaining second object 52 and the height position 50d of the top surface as the second measurement information. At this time, the information processing apparatus 10 temporarily stops operation control of the robot (step S5).

Then, the information processing apparatus 10 estimates the object shapes of the first object 51 and the second object 52 based on the second measurement information including the shape 50c and the height 50d of the second object 52 and the estimated shape of the first object 51 estimated as described above (step S6). Specifically, the information processing apparatus 10 estimates the object shape of the rectangular parallelepiped second object 52 whose bottom surface is the shape 50c included in the second measurement information and whose height h2 is the height 50d, as illustrated in FIG. 4 (4-2). In addition, as illustrated in FIG. 4 (4-2), the information processing apparatus 10 is able to calculate the height h1 of the first object 51 being picked up, by subtracting the height 50d (h2) of the second object 52 from the height 50b of the estimated shape of the object 50′ assumed to be a single object measured from the first measurement information as described above, and estimates the object shape of the first object 51.

Then, the information processing apparatus 10 creates an operation plan based on the estimated object shapes of the first object 51 and the second object 52 (step S7), and resumes operation control of the robot 30 to perform a picking operation according to the operation plan (step S8). In this case, as illustrated in FIG. 4 (4-2), the information processing apparatus 10 first creates an operation plan to place the first object 51 being picked up at the desired position according to the height h1 of the first object 51, and controls the operation of the robot 30. That is, the information processing apparatus 10 takes into account the height h1 of the first object 51 and creates an operation plan to control the operation of the robot 30 so as to properly place the first object 51 on the base G without dropping or crushing the first object 51. In addition, the information processing apparatus 10 controls the position of the robot 30 so as to hold the second object 52 at the height position 50c (h2) of the top surface of the object shape of the second object 52. Then, the operation control unit 11 causes the robot 30 to adsorb and hold the second object 52, and the second object 52 is held and moved by the robot 30.

In addition, if, after the robot 30 picks up the above-mentioned second object 52, another object remains in the location before it was picked up, the information processing apparatus 10 captures an image of the remaining object in the same manner as described above and measures its shape and height, and re-estimates the object shape, in particular, the height, of the picked second object 52 from the measurement results.

As described above, in this example embodiment, first, image capturing and measurement of an object is performed to estimate an estimated shape, and then, after the object is picked up, image capturing and measurement of the remaining object is performed to estimate the object shape of the object. Therefore, even when a plurality of objects are stacked, the height of each object can be measured appropriately. As a result, the robot can perform precise manipulation of the object.

Unlike the above description, when the first object 51 and the second object 52 are stacked, the information processing apparatus 10 may first perform imaging and measurement of the first object 51, and after picking up the first object 51, capture an image of the first object 51 again and estimate the object shape of the first object 51 based on the image. In this case, for example, after picking up the first object 51, it is preferable to capture an image that allows the height of the first object 51 to be measured such as by imaging the first object 51 from the side, and estimate the height of the first object 51. In addition to such imaging, the remaining second object 52 may be imaged in the same manner as described above and the object shape of the second object 52 may be estimated.

### Second Example Embodiment

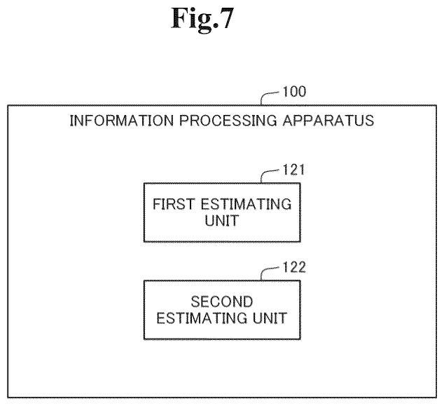

Next, a second example embodiment of the present disclosure will be described with reference to FIGS. 7 and 8. FIGS. 7 and 8 are block diagrams illustrating a configuration of an information processing apparatus according to the second example embodiment. This example embodiment shows the overview of the configuration of the information processing apparatus described in the above example embodiment.

First, the hardware configuration of an information processing apparatus 100 according to the present embodiment will be described with reference to FIG. 7. The information processing apparatus 100 is configured as a general information processing apparatus, and is equipped with the following hardware configuration, for example;
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing therein the programs 104;
a drive device 106 that performs reading from and writing into a storage medium 110 external to the information processing apparatus;
a communication interface 107 that connects to a communication network 111 external to the information processing apparatus;
an input/output interface 108 that performs input/output of data; and a bus 109 connecting the components.

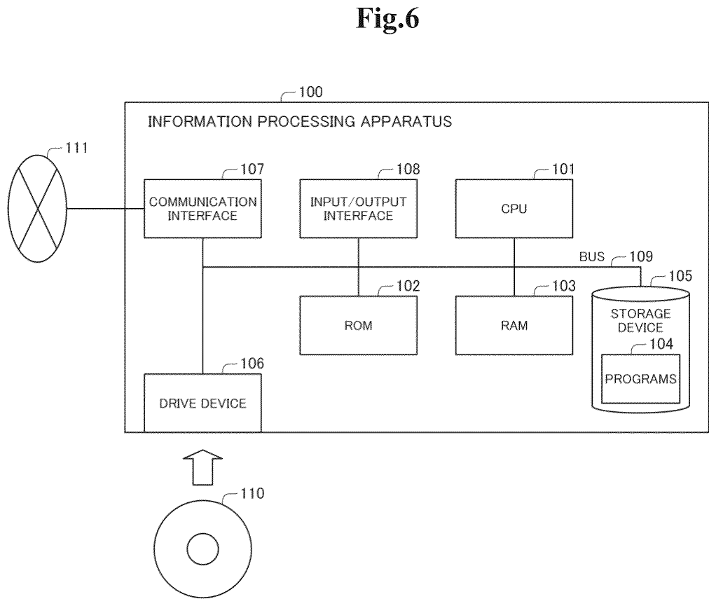

Note that FIG. 6 illustrates an example of the hardware configuration of the information processing apparatus 100, and the hardware configuration of the information processing apparatus is not limited to the above-mentioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The information processing apparatus 100 can construct and be equipped with a first estimating unit 121 and a second estimating unit 122 illustrated in FIG. 7 by the CPU 101 acquiring the programs 104 and executing them. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the first estimating unit 121 and the second estimating unit 122 described above may be constructed of dedicated electronic circuits for realizing such means.

The first estimating unit 121 acquires first measurement information obtained by measuring the shape of an object, and estimates an estimated shape of the object based on the first measurement information. For example, the first estimating unit 121 measures the shape of the stacked objects and estimates the estimated shape.

The second estimating unit 122 acquires second measurement information obtained by measuring the shape of an object after an object is manipulated by the robot, and estimates the shape of the object based on the estimated shape and the second measurement information. For example, the second estimating unit 122 acquires the second measurement information obtained by measuring the shape of the second object after the robot manipulates the first object of the stacked objects, and estimates the object shape of the first object based on the estimated shape and the second measurement information. Furthermore, after the robot manipulates one of the stacked objects, the second estimating unit 122 acquires the second measurement information obtained by measuring the shape of the remaining object that is not manipulated, and estimates the object shape of the manipulated object on the basis of the estimated shape of the stacked objects and the second measurement information.

Since the present disclosure is configured as described above, when objects are stacked, image capturing and measurement of an object are first performed to estimate the estimated shape of the stacked objects, and even after an object is manipulated by the robot, images of the manipulated object and any remaining objects that were not manipulated are imaged and measured to estimate the object shape of the manipulated object. Therefore, even when a plurality of objects are stacked, the shape of each object can be measured appropriately, enabling the robot to accurately manipulate the objects.

The aforementioned programs can be stored using various types of non-transitory computer-readable media and provided to a computer. The non-transitory computer-readable media include various types of tangible storage media. Examples of non-transitory computer-readable media include magnetic recording medium (e.g., flexible disk, magnetic tape, hard disk drive), magneto-optical recording medium (e.g., magneto-optical disk), read only memory (CD-ROM), CD-R, CD-R/W, and semiconductor memory (e.g., mask ROM, programmable ROM, Erasable PROM, flash ROM, random access memory (RAM)). In addition, a program may be provided to a computer by various types of transitory computer-readable medium. Examples of transitory computer-readable medium include electrical signals, optical signals, and electromagnetic waves. The transitory computer-readable medium may provide a program to the computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. Furthermore, at least one or more of the functions of the first estimating unit 121 and the second estimating unit 122 described above may be executed by an information processing apparatus installed and connected anywhere on the network, that is, they may be executed by so-called cloud computing.

### Supplementary Notes

The whole or part of the example embodiments disclosed above can be described as the following supplementary notes. Hereinafter, the overview of the configurations of an image processing apparatus, an image processing method, and a program according to the present disclosure will be described. However, the present disclosure is not limited to the following configuration.

### (Supplementary Note 1)

An information processing apparatus comprising:
a first estimating unit that acquires first measurement information obtained by measuring a shape of an object, and estimates an estimated shape of the object based on the first measurement information; and
a second estimating unit that acquires second measurement information obtained by measuring the shape of the object after the object is manipulated by a robot, and estimates an object shape based on the estimated shape and the second measurement information.

### (Supplementary Note 2)

The information processing apparatus according to supplementary note 1, wherein
the first estimating unit acquires the first measurement information obtained by measuring a shape of a first object, and estimates an estimated shape of the first object based on the first measurement information, and
the second estimating unit acquires the second measurement information obtained by measuring a shape of a second object after the first object is manipulated by the robot, and estimates an object shape of the first object based on the estimated shape and the second measurement information.

### (Supplementary Note 3)

The information processing apparatus according to supplementary note 2, wherein the second estimating unit acquires, after the first object is manipulated by the robot, the second measurement information obtained by measuring the shape of the second object located at a position of the first object before manipulation, and estimates the object shape of the first object based on the estimated shape and the second measurement information.

### (Supplementary Note 4)

The information processing apparatus according to supplementary note 3, wherein the second estimating unit estimates object shapes of the first object and the second object based on the estimated shape and the second measurement information.

### (Supplementary Note 5)

The information processing apparatus according to supplementary note 3 or 4, wherein
the first estimating unit acquires the first measurement information including a height of the first object, and
the second estimating unit acquires the second measurement information including a height of the second object, and estimates object shapes of the first object and the second object using heights included in the estimated shape and the second measurement information, respectively.

### (Supplementary Note 6)

The information processing apparatus according to supplementary note 4 or 5, further comprising
an operation control unit that calculates an operation plan of the robot based on the estimated object shapes of the first object and the second object, and controls an operation of the robot based on the operation plan.

### (Supplementary Note 7)

The information processing apparatus according to supplementary note 6, wherein the operation control unit calculates the operation plan when acquiring the second measurement information and estimating the object shapes of the first object and the second object.

### (Supplementary Note 8)

The information processing apparatus according to supplementary note 6 or 7, wherein
the operation control unit stops operation control of the robot when acquiring the second measurement information, estimates the object shapes of the first object and the second object and calculates a new operation plan, and then resumes the operation control of the robot based on the new operation plan.

### (Supplementary Note 9)

An information processing method comprising:
acquiring first measurement information obtained by measuring a shape of an object, and estimating an estimated shape of the object based on the first measurement information; and
acquiring second measurement information obtained by measuring the shape of the object after the object is manipulated by a robot, and estimating an object shape based on the estimated shape and the second measurement information.

### (Supplementary Note 10)

The information processing method according to supplementary note 9, further comprising:
acquiring the first measurement information obtained by measuring a shape of a first object, and estimating an estimated shape of the first object based on the first measurement information, and
acquiring the second measurement information obtained by measuring a shape of a second object after the first object is manipulated by the robot, and estimating an object shape of the first object based on the estimated shape and the second measurement information.

### (Supplementary Note 11)

The information processing method according to supplementary note 10, further comprising
after the first object is manipulated by the robot, acquiring the second measurement information obtained by measuring the shape of the second object located at a position of the first object before manipulation, and estimating the object shape of the first object based on the estimated shape and the second measurement information.

### (Supplementary Note 12)

The information processing method according to supplementary note 11, further comprising
estimating object shapes of the first object and the second object based on the estimated shape and the second measurement information.

### (Supplementary Note 13)

The information processing method according to supplementary note 12, further comprising
calculating an operation plan of the robot based on the estimated object shapes of the first object and the second object, and controlling an operation of the robot based on the operation plan.

### (Supplementary Note 14)

The information processing method according to supplementary note 13, further comprising
stopping operation control of the robot when acquiring the second measurement information, estimating the object shapes of the first object and the second object and calculating a new operation plan, and then resuming the operation control of the robot based on the new operation plan.

### (Supplementary Note 15)

A computer-readable medium storing thereon a program for causing a computer to execute processing to:
acquire first measurement information obtained by measuring a shape of an object, and estimate an estimated shape of the object based on the first measurement information; and
acquire second measurement information obtained by measuring the shape of the object after the object is manipulated by a robot, and estimate an object shape based on the estimated shape and the second measurement information.

### REFERENCE SIGNS LIST

10 information processing apparatus
11 operation control unit
12 measuring unit
13 first estimating unit
14 second estimating unit
16 operation plan storing unit
17 object shape storing unit
100 information processing apparatus
101 CPU
102 ROM
103 RAM
104 programs
105 storage device
106 drove device
107 communication interface
108 input/output interface
109 bus
110 storage medium
111 communication network
121 first estimating unit
122 second estimating unit

What is claimed is:

1. An information processing apparatus comprising:
at least one memory configured to store instructions; and
at least one processor configured to execute the instructions to:
acquire first measurement information obtained by measuring a shape of an object, and estimate an estimated shape of the object based on the first measurement information; and
acquire second measurement information obtained by measuring the shape of the object after the object is manipulated by a robot, and estimate an object shape based on the estimated shape and the second measurement information.

2. The information processing apparatus according to claim 1, wherein the at least one processor is configured to execute the instructions to:
acquire the first measurement information obtained by measuring a shape of a first object, and estimate an estimated shape of the first object based on the first measurement information; and
acquire the second measurement information obtained by measuring a shape of a second object after the first object is manipulated by the robot, and estimate an object shape of the first object based on the estimated shape and the second measurement information.

3. The information processing apparatus according to claim 2, wherein the at least one processor is configured to execute the instructions to,
after the first object is manipulated by the robot, acquire the second measurement information obtained by measuring the shape of the second object located at a position of the first object before manipulation, and estimate the object shape of the first object based on the estimated shape and the second measurement information.

4. The information processing apparatus according to claim 3, wherein the at least one processor is configured to execute the instructions to
estimate object shapes of the first object and the second object based on the estimated shape and the second measurement information.

5. The information processing apparatus according to claim 3, wherein the at least one processor is configured to execute the instructions to:
acquire the first measurement information including a height of the first object, and
acquire the second measurement information including a height of the second object, and estimate object shapes of the first object and the second object using heights included in the estimated shape and the second measurement information, respectively.

6. The information processing apparatus according to claim 4, wherein the at least one processor is configured to execute the instructions to
calculate an operation plan of the robot based on the estimated object shapes of the first object and the second object, and control an operation of the robot based on the operation plan.

7. The information processing apparatus according to claim 6, wherein the at least one processor is configured to execute the instructions to
calculate the operation plan when acquiring the second measurement information and estimating the object shapes of the first object and the second object.

8. The information processing apparatus according to claim 6, wherein the at least one processor is configured to execute the instructions to
stop operation control of the robot when acquiring the second measurement information, estimate the object shapes of the first object and the second object and calculate a new operation plan, and then resume the operation control of the robot based on the new operation plan.

9. An information processing method comprising:
acquiring first measurement information obtained by measuring a shape of an object, and estimating an estimated shape of the object based on the first measurement information; and
acquiring second measurement information obtained by measuring the shape of the object after the object is manipulated by a robot, and estimating an object shape based on the estimated shape and the second measurement information.

10. The information processing method according to claim 9, further comprising:
acquiring the first measurement information obtained by measuring a shape of a first object, and estimating an estimated shape of the first object based on the first measurement information, and
acquiring the second measurement information obtained by measuring a shape of a second object after the first object is manipulated by the robot, and estimating an object shape of the first object based on the estimated shape and the second measurement information.

11. The information processing method according to claim 10, further comprising
after the first object is manipulated by the robot, acquiring the second measurement information obtained by measuring the shape of the second object located at a position of the first object before manipulation, and estimating the object shape of the first object based on the estimated shape and the second measurement information.

12. The information processing method according to claim 11, further comprising
estimating object shapes of the first object and the second object based on the estimated shape and the second measurement information.

13. The information processing method according to claim 12, further comprising
calculating an operation plan of the robot based on the estimated object shapes of the first object and the second object, and controlling an operation of the robot based on the operation plan.

14. The information processing method according to claim 13, further comprising
stopping operation control of the robot when acquiring the second measurement information, estimating the object shapes of the first object and the second object and calculating a new operation plan, and then resuming the operation control of the robot based on the new operation plan.

15. A non-transitory computer-readable medium storing thereon a program comprising instructions for causing a computer to execute processing to:
acquire first measurement information obtained by measuring a shape of an object, and estimate an estimated shape of the object based on the first measurement information; and
acquire second measurement information obtained by measuring the shape of the object after the object is manipulated by a robot, and estimate an object shape based on the estimated shape and the second measurement information.
